(19) United States
(12) Patent Application Publication
(10) Pub. No.: US 2008/0160472 A1
(43) Pub. Date: Jul. 3, 2008

(54) Sinter furnace for sapphire crystal growth

(76) Inventor: Yu-Feng Chang, Bade City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/645,933

(22) Filed: Dec. 27, 2006

(51) Int. Cl. F27B 14/00

(52) U.S. Cl. 432/13

(57) ABSTRACT

A sinter furnace for sapphire crystal growth includes an outer furnace, and an inner furnace mounted in the outer furnace. The inner furnace includes a furnace bed, a furnace body detachably mounted on the furnace bed, a gas inlet pipe mounted in the furnace body, and a gas outlet pipe mounted on the furnace body. Thus, the inert gas is introduced through the gas inlet pipe into the furnace body and the used inert gas is drained outwardly from the gas outlet pipe to enhance the air circulation in the furnace body so that the heat contained in the furnace body is distributed evenly so as to enhance the quality of the sapphire crystal.

### BACKGROUND OF THE INVENTION

1. Field of the Invention

The present invention relates to a sinter furnace and, more particularly, to a sinter furnace for a sapphire crystal growth.

2. Description of the Related Art

A sapphire (single-crystal aluminum oxide or alumina) is available for making a substrate of a semi-conductor product, such as an LED (light emitting diode) or the like. A conventional high temperature sinter furnace for a sapphire crystal growth comprises a furnace body containing aluminum oxide powder, and an inert gas is introduced into the furnace body so as to perform a sintering process in the furnace body so as to obtain a sapphire crystal. However, the temperature in the furnace body is not controlled easily, thereby decreasing the quality of the sapphire crystal product. In addition, the sapphire crystal has limited mass and size, has a lower quality, has a higher price and has a longer growing time.

### BRIEF SUMMARY OF THE INVENTION

In accordance with the present invention, there is provided a sinter furnace, comprising an outer furnace, and an inner furnace mounted in the outer furnace. The inner furnace includes a furnace bed, a furnace body detachably mounted on the furnace bed, a gas inlet pipe mounted in the furnace body, and a gas outlet pipe mounted on and partially protruded outwardly from the furnace body.

The primary objective of the present invention is to provide a sinter furnace, wherein the inert gas is introduced through the gas inlet pipe into the furnace body and the used inert gas is drained outwardly from the gas outlet pipe to enhance the air circulation in the furnace body so that the heat contained in the furnace body is distributed evenly so as to enhance the quality of the sapphire crystal.

Another objective of the present invention is to provide a sinter furnace, wherein the sapphire crystal growth needs a shorter time.

A further objective of the present invention is to provide a sinter furnace, wherein the sapphire crystal growth has a lower price.

A further objective of the present invention is to provide a sinter furnace, wherein the mass and size of the sapphire crystal are unlimited.

A further objective of the present invention is to provide a sinter furnace, wherein the sapphire crystal has a higher quality. Further, the solid-liquid interface is encompassed by the melt during the crystal growth, so that the temperature and mechanical perturbations on the surface of the crystal are reduced or eliminated by the melt, thereby enhancing the quality of the crystal.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional view of a sinter furnace in accordance with the preferred embodiment of the present invention.

FIG. 2 is a locally enlarged view of the sinter furnace as shown in FIG. 1.

### DETAILED DESCRIPTION OF THE INVENTION

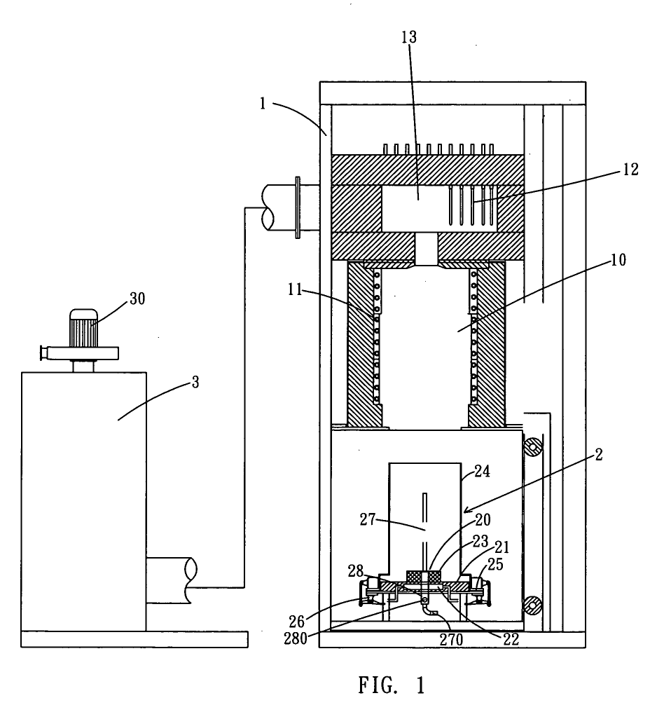

Referring to the drawings and initially to FIG. 1, a sinter furnace for sapphire crystal growth in accordance with the preferred embodiment of the present invention comprises an outer furnace 1, an inner furnace 2 mounted in the outer furnace 1, and a cooling and dust collection device 3 mounted on an outside of and connected to the outer furnace 1.

The outer furnace 1 has an inside formed with a heating space 10 to receive the inner furnace 2. A heating device 11 is mounted on an inner side of the heating space 10 of the outer furnace 1. The heating space 10 of the outer furnace 1 has an upper portion provided with a secondary combustion chamber 13 connected to the cooling and dust collection device 3. A secondary heating device 12 is mounted on an inner side of the secondary combustion chamber 13 of the outer furnace 1. The cooling and dust collection device 3 is used to cool the gas after a complete combustion of the secondary combustion chamber 13 of the outer furnace 1 and to filter impurities contained in the gas. The cooling and dust collection device 3 is provided with a ventilating device 30 to drain the filtered gas outwardly from the cooling and dust collection device 3.

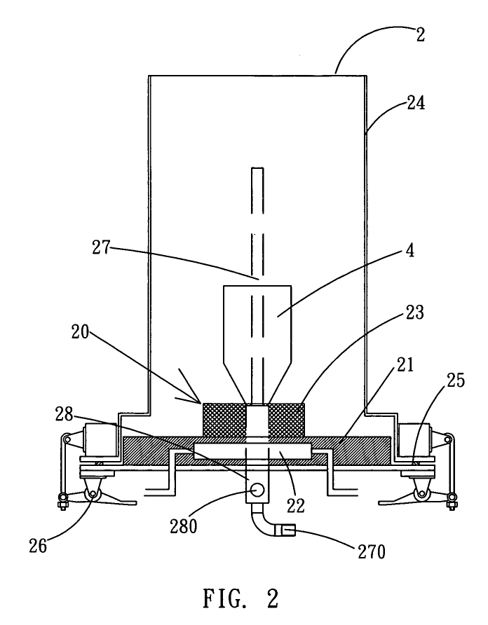

Referring to FIGS. 1 and 2, the inner furnace 2 includes a furnace bed 20, a furnace body 24 detachably mounted on the furnace bed 20, a gas inlet pipe 27 mounted in the furnace body 24, and a gas outlet pipe 28 mounted on and partially protruded outwardly from the furnace body 24.

The furnace body 24 of the inner furnace 2 is detachably mounted on the furnace bed 20 of the inner furnace 2 by a fastening device 26. Preferably, the fastening device 26 is a quick release connector or a bolt and nut combination.

The gas inlet pipe 27 has a first end mounted in the furnace body 24 and a second end protruded outwardly from the furnace body 24. The second end of the gas inlet pipe 27 is formed with a gas inlet port 270 to introduce an inert gas through the gas inlet pipe 27 into the furnace body 24. The gas outlet pipe 28 has a first end mounted in the furnace body 24 and a second end protruded outwardly from the furnace body 24. The second end of the gas outlet pipe 28 is formed with a gas outlet port 280 to drain the inert gas in the furnace body 24 outwardly. The gas outlet pipe 28 is co-axially mounted around an outer side of the second end of the gas inlet pipe 27. The gas outlet pipe 28 has a diameter greater than that of the gas inlet pipe 27 and has a length shorter than that of the gas inlet pipe 27. Thus, the inert gas is introduced through the gas inlet pipe 27 into the furnace body 24 and the used inert gas is drained outwardly from the gas outlet pipe 28 to enhance the air circulation in the furnace body 24 so that the heat contained in the furnace body 24 is distributed evenly so as to enhance the quality of the sapphire crystal.

The inner furnace 2 further includes a heat insulating layer 21 mounted on a bottom of the furnace bed 20, a cooling circulation device 22 mounted on the bottom of the furnace bed 20, a heater 23 mounted on a top of the furnace bed 20, a seal device 25 mounted between the furnace bed 20 and the furnace body 24 to seal the furnace bed 20 and the furnace body 24 to prevent the inert gas from leaking outwardly from the furnace body 24, and a crucible 4 mounted in the furnace body 24 and located above the furnace bed 20 to receive an aluminum oxide (Al₂O₃) cake (not shown) that has been pre-sintered. Preferably, the seal device 25 is made of rubber or silicone gel material.

In fabrication, a sapphire crystal growth method in accordance with the preferred embodiment of the present invention comprises a first step of grinding, a second step of purification, a third step of spraying and drying particles, a fourth step of adding organic bonding agent, a fifth step of press molding, and a sixth step of crystal growth. The first step of grinding includes crushing and grinding the powder of an aluminum oxide (Al₂O₃) into micro powder particles. The second step of purification includes purifying the powder particles of the aluminum oxide to reach a purity more than 99.999%. The third step of spraying and drying particles includes stirring the purified powder particles of the aluminum oxide to form a glue-shaped aluminum oxide, pressurizing the glue-shaped aluminum oxide, spraying the glue-shaped aluminum oxide, and drying the glue-shaped aluminum oxide to form aluminum oxide particles having uniform sizes. The fourth step of adding organic bonding agent includes adding an organic bonding agent into the aluminum oxide particles having uniform sizes. The fifth step of press molding includes press molding the aluminum oxide particles having uniform sizes to form an aluminum oxide blank having a predetermined shape. The sixth step of crystal growth includes pre-sintering the aluminum oxide blank having a predetermined shape into an aluminum oxide cake disposed at a half-baked state, heating the aluminum oxide cake into a melted state until aluminum oxide crystals are grown, and solidifying, cooling and shrinking the aluminum oxide crystals into a single-crystal sapphire. The single-crystal sapphire is an artificial aluminum oxide crystal.

In the sixth step of crystal growth, the aluminum oxide blank having a predetermined shape is pre-sintered on the furnace bed 20 of the inner furnace 2 at a high temperature (more than 1600° C.) to eliminate tiny organic substances, impurities and air bubbles contained in the aluminum oxide blank to form the half-baked aluminum oxide cake having a compact specific density. The organic substances and impurities are floated easily and have a lighter weight so that they can be eliminated at a high temperature. At this time, the gas containing impurities is introduced into the secondary combustion chamber 13 of the outer furnace 1 by action of the ventilating device 30 so that the impurities are combusted completely by the high temperature in the secondary combustion chamber 13 of the outer furnace 1. Then, the gas that has been combusted completely in the secondary combustion chamber 13 of the outer furnace 1 is introduced into and cooled by the cooling and dust collection device 3, and the impurities contained in the gas is filtered by the cooling and dust collection device 3. Then, the ventilating device 30 drains the filtered gas outwardly from the cooling and dust collection device 3. Then, the aluminum oxide cake that has been pre-sintered is placed into the crucible 4 which is located above the furnace bed 20. The crucible 4 has a bottom face containing a seed crystal (not shown) to obtain a correct orientation of a sapphire crystal growth. Then, the furnace body 24 of the inner furnace 2 is combined with the furnace bed 20 of the inner furnace 2 by the fastening device 26. Then, the furnace body 24 of the inner furnace 2 is evacuated, and the inert gas is introduced through the gas inlet pipe 27 into the furnace body 24. Then, the temperature in the furnace body 24 of the inner furnace 2 is increased by the heater 23 to heat the aluminum oxide cake into a melted state until the aluminum oxide crystals are grown. Then, the aluminum oxide crystals are solidified, cooled and shrunk to form the single-crystal sapphire. At this time, the heat insulating layer 21 and the cooling circulation device 22 of the inner furnace 2 are used to reduce the temperature to prevent the seed crystal and the seal device 25 from being burned out.

In the present invention, the crucible 4 is made of metallic material, such as molybdenum (Mo), zirconium (Zr), Platinum (Pt) and the like. In addition, the temperature of the present invention is set at about 2040° C. to 2100° C. In addition, the sapphire crystal growth method of the present invention saves a growing time of one time, saves an energy lost of one time, has a lower price, has crystals whose mass and size are unlimited, and has a higher quality.

Accordingly, the inert gas is introduced through the gas inlet pipe 27 into the furnace body 24 and the used inert gas is drained outwardly from the gas outlet pipe 28 to enhance the air circulation in the furnace body 24 so that the heat contained in the furnace body 24 is distributed evenly so as to enhance the quality of the sapphire crystal. In addition, the sapphire crystal growth needs a shorter time. Further, the sapphire crystal growth has a lower price. Further, the mass and size of the sapphire crystal are unlimited. Further, the sapphire crystal has a higher quality. Further, the solid-liquid interface is encompassed by the melt during the crystal growth, so that the temperature and mechanical perturbations on the surface of the crystal are reduced or eliminated by the melt, thereby enhancing the quality of the crystal.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A sinter furnace, comprising:
an outer furnace;
an inner furnace mounted in the outer furnace and including a furnace bed, a furnace body detachably mounted on the furnace bed, a gas inlet pipe mounted in the furnace body, and a gas outlet pipe mounted on and partially protruded outwardly from the furnace body.

2. The sinter furnace in accordance with claim 1, wherein the furnace body of the inner furnace is detachably mounted on the furnace bed of the inner furnace by a fastening device.

3. The sinter furnace in accordance with claim 2, wherein the fastening device is a quick release connector or a bolt and nut combination.

4. The sinter furnace in accordance with claim 1, wherein the gas inlet pipe has a first end mounted in the furnace body and a second end protruded outwardly from the furnace body, and the gas outlet pipe has a first end mounted in the furnace body and a second end protruded outwardly from the furnace body.

5. The sinter furnace in accordance with claim 4, wherein the second end of the gas inlet pipe is formed with a gas inlet port to introduce an inert gas through the gas inlet pipe into the furnace body, and the second end of the gas outlet pipe is formed with a gas outlet port to drain the inert gas in the furnace body outwardly.

6. The sinter furnace in accordance with claim 4, wherein the gas outlet pipe is co-axially mounted around an outer side of the second end of the gas inlet pipe.

7. The sinter furnace in accordance with claim 4, wherein the gas outlet pipe has a diameter greater than that of the gas inlet pipe.

8. The sinter furnace in accordance with claim 4, wherein the gas outlet pipe has a length shorter than that of the gas inlet pipe.

9. The sinter furnace in accordance with claim 5, wherein the inert gas is introduced through the gas inlet pipe into the furnace body and used inert gas is drained outwardly from the gas outlet pipe to enhance a air circulation in the furnace body so that a heat contained in the furnace body is distributed evenly.

10. The sinter furnace in accordance with claim 1, wherein the inner furnace further includes a heat insulating layer mounted on a bottom of the furnace bed.

11. The sinter furnace in accordance with claim 1, wherein inner furnace further includes a cooling circulation device mounted on a bottom of the furnace bed.

12. The sinter furnace in accordance with claim 1, wherein inner furnace further includes a heater mounted on a top of the furnace bed.

13. The sinter furnace in accordance with claim 5, wherein inner furnace further includes a seal device mounted between the furnace bed and the furnace body to seal the furnace bed and the furnace body to prevent the inert gas from leaking outwardly from the furnace body.

14. The sinter furnace in accordance with claim 1, wherein the inner furnace further includes a crucible mounted in the furnace body and located above the furnace bed.

15. The sinter furnace in accordance with claim 1, wherein the outer furnace has an inside formed with a heating space to receive the inner furnace, and the heating space of the outer furnace has an upper portion provided with a secondary combustion chamber.

16. The sinter furnace in accordance with claim 15, further comprising a heating device mounted on an inner side of the heating space of the outer furnace.

17. The sinter furnace in accordance with claim 15, further comprising a secondary heating device mounted on an inner side of the secondary combustion chamber of the outer furnace.

18. The sinter furnace in accordance with claim 15, further comprising a cooling and dust collection device mounted on an outside of and connected to the outer furnace.

19. The sinter furnace in accordance with claim 18, wherein the cooling and dust collection device is connected to the secondary combustion chamber of the outer furnace.

20. The sinter furnace in accordance with claim 19, wherein the cooling and dust collection device is provided with a ventilating device.
